(19) United States
(12) Patent Application Publication
(10) Pub. No.: US 2010/0024610 A1
(43) Pub. Date: Feb. 4, 2010

(54) ASSEMBLY/DISASSEMBLY PLIERS

(75) Inventors: Wen-Hua Chen, Taipei (TW); Wei-Hung Lu, Taipei (TW); Hsin-Fa Liu, Taipei (TW); Yu-Chung Huang, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/234,845

(22) Filed: Sep. 22, 2008

(30) Foreign Application Priority Data
Aug. 1, 2008 (TW) 097129352

(51) Int. Cl. B25B 7/00

(52) U.S. Cl. 81/427.5

(57) ABSTRACT

An assembly/disassembly pliers including two pivoted pliers bodies is used to assemble or disassemble a heat sink on or from a chip. The heat sink is disposed in a fixing member, and two hooks of the fixing member are buckled with the chip. An actuating handle and an operating board are respectively disposed on each pliers body, and a bump is extended from at least one operating board. The two actuating handles are actuated to drive the two operating boards to open towards opposite directions, such that the bumps push the fixing member and release the hooks, such that the fixing member and the heat sink are installed on or separated from the chip.

### CROSS-REFERENCE TO RELATED APPLICATIONS

This non-provisional application claims priority under 35 U.S.C. §119(a) on Patent Application No(s). 097129352 filed in Taiwan, R.O.C. on Aug. 1, 2008 the entire contents of which are hereby incorporated by reference.

### BACKGROUND OF THE INVENTION

1. Field of Invention

The present invention relates to a disassembly tool, and more particularly to an assembly/disassembly pliers for assembling and disassembling a heat sink installed on a chip.

2. Related Art

For early package manners applied to integrated circuits (ICs), no matter jack elements are adopted, for example, dual in-line package (DIP), single in-line package (SIP), and other bonding manners, or surface mounted elements are adopted, for example, quad flat pack (QFP), small outline package (SOP), and other bonding manners, mostly a lead frame is used as a carrier. That is to say, a chip electrode and pins on the lead frame are connected by using a gold wire, and peripheral pins of the lead frame are used as a circuit I/O pipeline, so the reducing of the package volume and the increasing of the I/O pin number are still limited.

After entering post personal computer (PC) times, information transmission capacity is greatly expanded, and signal transmission speed is rapidly improved, such that IC process must be developed towards the direction of high capacity, small wire interval, high frequency, and low power consumption etc. For the IC package fabricating process, in order to meet the high standard demand of high I/O pin number, high heat dissipation, and reduced package scale, packaging manners using IC carriers are derived, for example, area array type package such as ball grid array (BGA) package and chip scale package (CSP) package, and flip chip type package such as flip chip ball grid array (FCBGA) package and flip chip pin grid array (FCPGA)/BGA package. Therefore, the demands of high I/O pin number, high speed, high power, and thin type are satisfied.

The BGA package is an IC packaging manner in which a solder ball is used as an IC pin, and is quite common in electronic industry. In the past, the industry usually used Sn—Pb alloy (63/37) as a material of BGA solder ball. However, Pb in the Sn—Pb alloy (63/37) seriously pollutes the environment, and it is quite difficult to solve the problem of the pollution during the fabricating process or the subsequent recycle of the product. Therefore, some Pb free fabricating processes are proposed in some countries in the world. For example, in the restriction of hazardous substances in electrical and electronic equipment (RoHS) of EU, it is regulated that the manufacturers are wholly prohibited from using six hazardous substances including Pb, Hg, Cd, Cr⁺⁶, PBBs, and PBDEs in the products or components, so as to reduce the impact on the environment. In response to the RoHS of EU, the material of the BGA solder ball is changed to Pb free Sn—Ag—Cu alloy in the industry.

During the Pb free fabricating process adopting the Sn—Ag—Cu alloy, because of the limit of the material characteristics, the scale of the solder ball in the BGA fabricating process is smaller than the solder ball in the fabricating processing adopting the Sn—Pb alloy, and an adhesive force between the chip and a circuit board is reduced. Referring to FIG. 1, a structure of a recent chip package produced by adopting the Pb free BGA fabricating process is shown. A chip 11 is fixed on and electrically connected to the circuit board 10 through solder balls 15. A heat sink 12 is disposed on the chip 11, and the heat sink 12 is assembled on the chip 11 through a fixing member 13. Hooks 131 on two sides of the fixing member 13 are buckled with edges of the chip 11, such that the fixing member 13 presses the heat sink 12 to attach to the chip 11. When it is necessary to disassemble and replace the heat sink 12, recently, a rod 14 is mostly used to disassemble the fixing member 13 and the heat sink 12 in the industry.

However, the Pb free fabricating process results in a reduced adhesive force of the solder balls 15, so the external force endured by the solder balls 15 is also smaller and the rod 14 can only open the hook 131 on one side of the fixing member 13, while the hook 131 on the other side is still buckled with the edge of the chip 11. Thus, the user must perform the disassembly quite carefully. A slightly larger force may damage the soldering structure between the solder balls 15 and the chip 11 or the circuit board 10, thus damaging the circuit wires, which results in quite complicated assembly and the disassembly procedures, and what is the worse, the chip 11 may also be deformed. Thus, the disassembly tool (rod 14) used in the industry is not applicable to the chip fabricated by adopting the Pb free fabricating process. Alternatively, during the process of assembling the fixing member 13 on the chip 11, if the operator over-presses the fixing member, the soldering structure between the solder balls 15 and the chip 11 or the circuit board 10 may also be easily damage.

The solder balls 15 are usually damaged in the assembly or the disassembly process of the heat sink 12, which results in the circuit contact failure that is difficultly found by naked eyes, such that the yield of the chip product on the production line is reduced. Therefore, not only the production cost is increased, but also it is impossible to satisfy the commercial benefit.

### SUMMARY OF THE INVENTION

In the chip package structure fabricated by adopting the Pb free BGA fabricating process in the prior art, the adhesive force of the solder bass is reduced, and thus if the recently used disassembly tool is used to disassemble the heat sink of the chip, it is quite inconvenient on the disassembly procedure, and the solder balls may be easily damaged. During the process of assembling the heat sink, it is also easy to over-press the fixing member to damage the solder balls. Accordingly, the present invention provides an assembly/disassembly pliers capable of more conveniently assembling or disassembling the heat sink on or from the chip fabricated by adopting the Pb free BGA fabricating process, and preventing the solder balls or the fixing member from being damaged during the assembling/disassembling process.

The assembly/disassembly pliers according to the present invention is used to assemble or disassemble a heat sink on or from a chip. The chip is substantially fabricated by adopting the Pb free BGA fabricating process, and is fixed on a circuit board through a plurality of solder balls. The heat sink is installed in a fixing member, and the fixing member has at least two opposite hooks and at least two through-holes disposed beside each hook. The hooks of the fixing member are buckled with edges of the chip, such that the heat sink is attached to the chip.

The assembly/disassembly pliers of the present invention includes two pivoted pliers bodies, and each pliers body has a pivoting portion, an actuating handle and an operating board respectively disposed on two ends of the pivoting portion. An opening scope is formed between the two operating boards. Each operating board has at least one extending portion, a bump is raised on the at least one extending portion, and the bump of the extending portion is disposed towards a direction opposite to the other operating board. Each extending portion is inserted into the through-hole of the fixing member and leans against the hook through the bump thereof. When the two actuating handles are actuated to approach each other, the two operating boards are driven to shift towards opposite directions to expand the opening scope, and the bumps push the hooks to be buckled with or separated from the chip, such that the fixing member and the heat sink are installed on or separated from the chip.

The efficacy of the present invention is that by using the operating board of each pliers body and the bumps disposed back to back on the front ends of the extending portions, the user may operate the actuating handle of each pliers body to make the operating board on the other end open outwards, so as to easily open the hooks on the two sides of the chip through the bumps, thereby conveniently assembling or disassembling the heat sink on or from the chip fabricated by adopting the Pb free BGA fabricating process, and preventing the solder balls from being damaged during the assembling/disassembling process of the fixing member and the heat sink. Therefore, the yield of the chip product on the production line is increased to have extremely high commercial benefit.

### BRIEF DESCRIPTION OF THE DRAWINGS

The present invention will become more fully understood from the detailed description given herein below for illustration only, and thus are not limitative of the present invention, and wherein:

FIG. 1 is a schematic view of disassembling a heat sink on a chip by using a conventional rod in prior art;

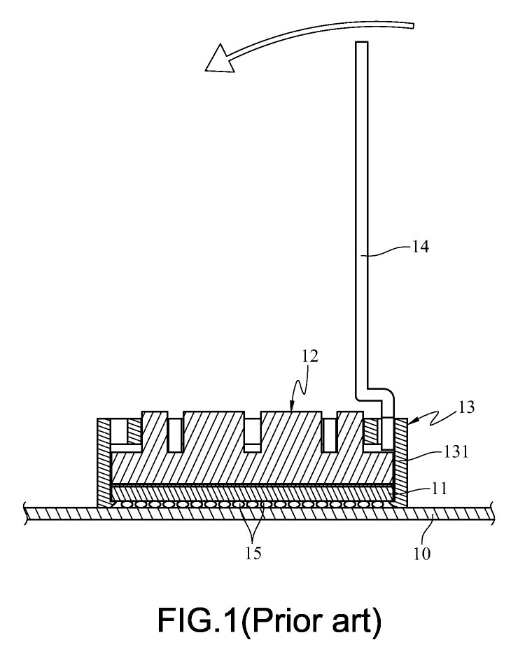

FIG. 2 is an exploded view of a first embodiment of the present invention;

FIG. 3 is a schematic view of the first embodiment of the present invention;

FIG. 4 is an exploded view of a heat sink component in the present invention;

FIG. 5 is an exploded view of assembling the heat sink component on the chip by using an assembly/disassembly pliers according to the first embodiment of the present invention;

FIG. 6 is a cross sectional exploded view of assembling the heat sink component on the chip by using the assembly/disassembly pliers according to the first embodiment of the present invention;

FIG. 7 is a cross sectional exploded view of disassembling the heat sink component from the chip by using the assembly/disassembly pliers according to the first embodiment of the present invention;

FIG. 8 is a cross sectional exploded view of disassembling the heat sink component from the chip by using the assembly/disassembly pliers according to the first embodiment of the present invention;

FIG. 9 is a cross sectional exploded view of disassembling the heat sink component from the chip by using the assembly/disassembly pliers according to the first embodiment of the present invention;

FIG. 10 is an exploded view of a second embodiment in the present invention;

FIG. 11 is an exploded view of assembling the heat sink component on the chip by using the assembly/disassembly pliers according to the second embodiment of the present invention;

FIG. 12 is a cross sectional exploded view of disassembling the heat sink component from the chip by using the assembly/disassembly pliers according to the second embodiment of the present invention; and

FIG. 13 is a cross sectional exploded view of disassembling the heat sink component from the chip by using the assembly/disassembly pliers according to the second embodiment of the present invention.

### DETAILED DESCRIPTION OF THE INVENTION

In order to have a further understanding of the objective, the structure, the feature, and the function of the present invention, a detailed description is given as follows with the embodiments.

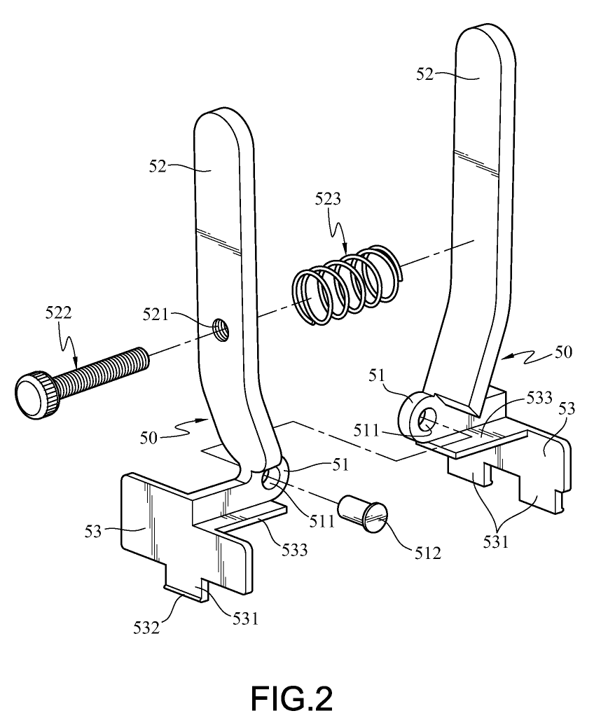

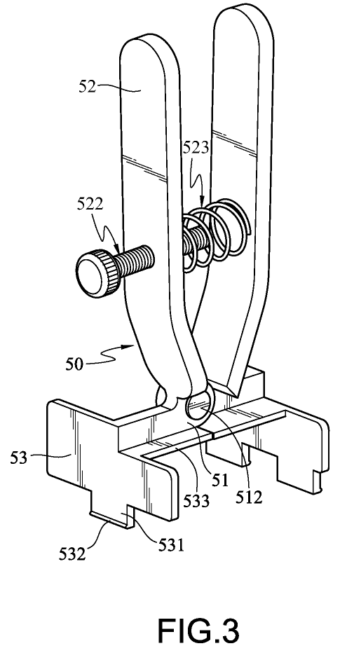

Referring to FIGS. 2 and 3, an assembly/disassembly pliers according to a first embodiment of the present invention is shown. The assembly/disassembly pliers of the present invention includes two pliers bodies 50 pivoted to each other, an adjusting screw rod 522, a spring 523, and a pin 512, and each pliers body 50 has a pivoting portion 51, an actuating handle 52, and an operating board 53.

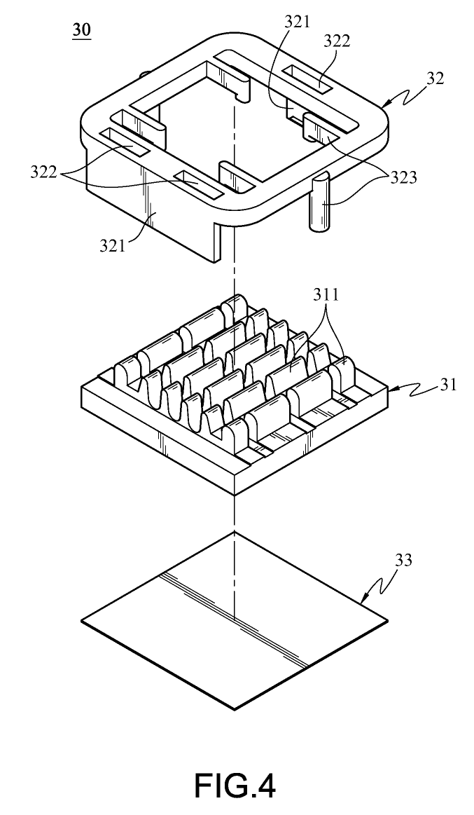

Referring to FIGS. 4, 5, and 6, the assembly/disassembly pliers according to the first embodiment of the present invention is used to assemble or disassemble a heat sink component 30 on or from a chip 21. The heat sink component 30 includes a heat sink 31, a fixing member 32, and a thermally conductive film 33. The chip 21 is substantially a chip fabricated by adopting the Pb free BGA fabricating process, and is fixed on a circuit board 20 through a plurality of solder balls 22. The heat sink 31 has a plurality of heat sink bumps 311 for increasing the heat dissipation area of the heat sink 31. The fixing member 32 has two opposite hooks 321, a plurality of through-holes 322, and a plurality of positioning portions 323, in which each through-hole 322 is respectively disposed beside each hook 321.

The heat sink 31 is installed in the fixing member 32, so as to be assembled on the chip 21 through the fixing member 32. The appearance of the positioning portion 323 is matched with that of the heat sink 31, such that the heat sink 31 is positioned in the fixing member 32. The hooks 321 of the fixing member 32 are buckled with the edges of the two opposite sides of the chip 21, such that the heat sink 31 is attached to the chip 21. The thermally conductive film 33 is attached between the heat sink 31 and the chip 21, and is used for thermal conduction. In practice, the heat sink 31 is installed between the fixing member 32 and the chip 21, and the hooks 321 of the fixing member 32 are buckled with the chip 21, so as to press the heat sink 31, the thermally conductive film 33, and the chip 21 to closely contact with one another.

Referring to FIGS. 2 to 5, the pivoting portion 51 is located in the middle of the pliers body 50, and the actuating handle 52 and the operating board 53 are respectively disposed on two ends of the pivoting portion 51. The pivoting portion 51 of each pliers body 50 has a pivot hole 511, in which the pin 512 passes through the pivot hole 511 of each pivoting portion 51, so as to pivot the two pliers bodies 50. The operating board 53 of each pliers body 50 has one or more extending portions 531, and a bump 532 is disposed on an edge of the front end of each extending portion 531. The bumps 532 on the extending portions 531 of a different pliers body 50 are disposed towards the direction opposite to the other operating board 53, that is, the bumps 532 are disposed back to back. It should be noted that the bumps 532 of the present invention may also be correspondingly disposed on one of the extending portions 531 matching with the appearance of the fixing member 32, but in the drawings of the present invention, for the description of the most preferred embodiment, a bump 532 is respectively disposed on each extending portion 531, but it is not limited to the embodiment of the present invention.

A stopping portion 533 is disposed between the operating board 53 and the pivoting portion 51 of each pliers body 50, in which edges of the stopping portions 533 lean against each other, so as to stop the operating boards 53 of the two pliers bodies 50 from approaching each other. When the stopping portions 533 of the pliers bodies 50 lean against each other, an opening scope is formed between the two operating boards 53, and the opening scope is slightly larger than a pitch of the through-holes 322 on the two sides of the fixing member 32. In this manner, the two actuating handles 52 may be actuated to approach each other, so as to drive the two operating boards 53 to shift towards opposite directions to expand the opening scope. That is to say, as long as the user holds the two actuating handles 52 and applies the force to squeeze, it is possible to open the two operating boards 53 outwards.

Referring to FIGS. 2 to 6, a threaded hole 521 is disposed on one of the two actuating handles 52, and the adjusting screw rod 522 is screwed in the threaded hole 521 and passes through the actuating handle 52. An operating pitch is formed between the front end of the adjusting screw rod 522 and the other actuating handle 52, so as to limit an actuating scope of the two actuating handles 52, that is, the two actuating handles 52 may approach each other until the front end of the adjusting screw rod 522 leans against the other actuating handle 52. The adjusting screw rod 522 may rotate relative to the actuating handle 52 to a specific position, so as to adjust the operating pitch, thereby adjusting the actuating scope of the two actuating handles 52.

The spring 523 is substantially a compression spring, and is disposed between the actuating handles 52 of the two pliers bodies 50. Two ends of the spring 523 respectively lean against the inner sides of the two actuating handles 52, and the adjusting screw rod 522 may pass through the spring 523, thereby preventing the spring 523 from falling off in a simple manner. Practically, an original length of the spring 523 is larger than the pitch of the two actuating handles 52, so when the spring 523 is installed between the two actuating handles 52, the two actuating handles 52 may compress the spring 523. Oppositely, the spring 523 is compressed to provide an elastic force, so as to normally push the two actuating handles 52 towards opposite directions. Under the situation that the spring 523 continuously pushes the two actuating handles 52 towards two sides, the edges of the stopping portions 533 of the two pliers bodies 50 are made to lean against each other, and the two operating boards 53 are maintain in the opening scope.

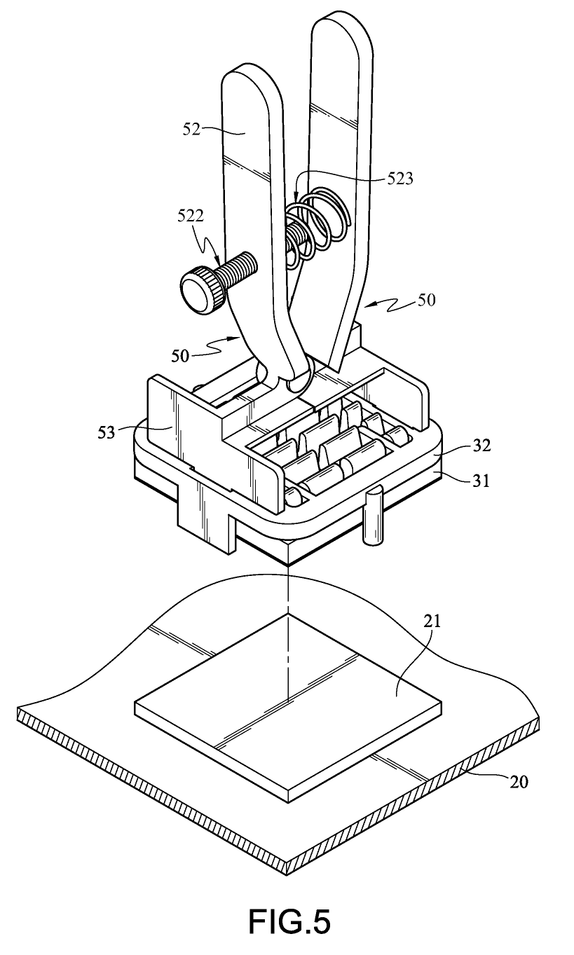

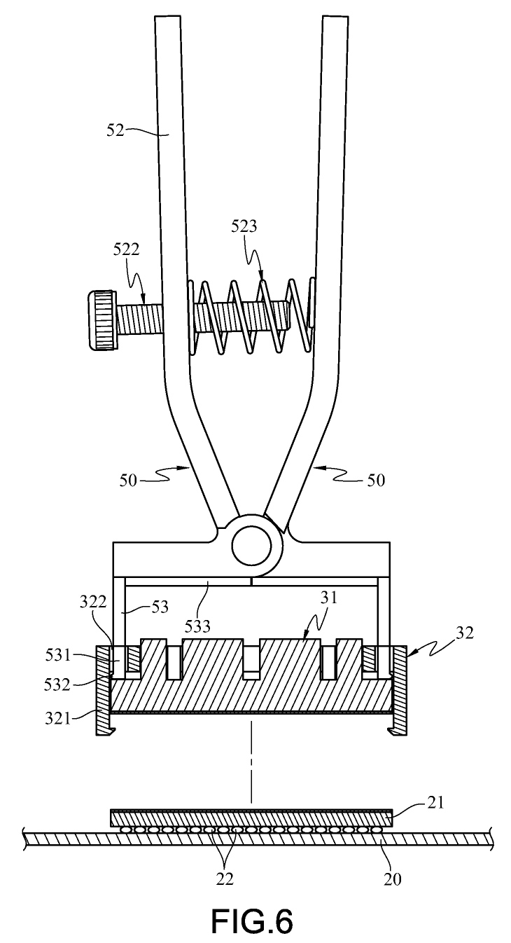

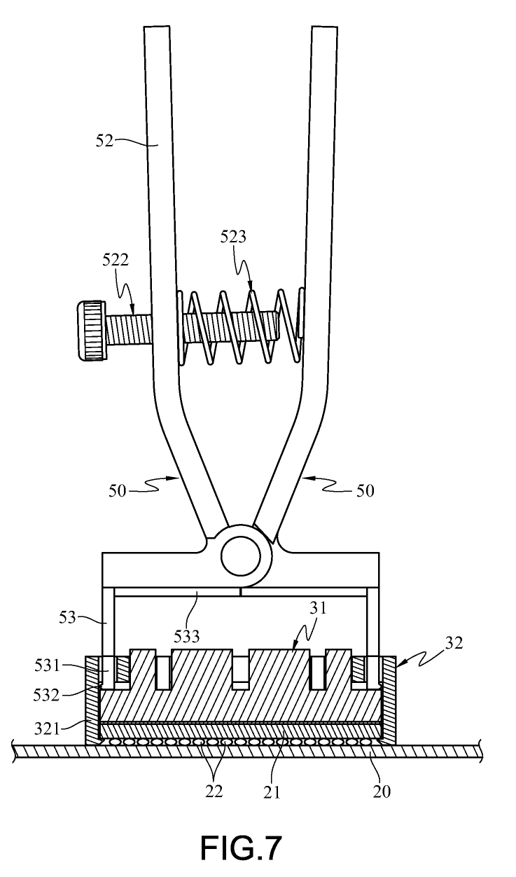

Referring to FIGS. 2, 5, 6, and 7, when the user intends to assemble the heat sink component 30 on the chip 21 by using the assembly/disassembly pliers of the present invention, it is possible to insert each extending portion 531 of the two pliers bodies 50 into the corresponding through-hole 322 on the fixing member 32, and make the bump 532 on each extending portion 531 lean against a base portion of the hook 321. Then, the two actuating handles 52 are squeezed inwards to slightly open the two operating boards 53, so as to seize the heat sink component 30 outwards (referring to FIGS. 5 and 6). Next, the heat sink component 30 is pushed in a manner of being aligned with the chip 21, the hooks 321 of the fixing member 32 may firstly open and then are buckled with the edges of the chip 21 (referring to FIG. 7), such that the heat sink component 30 is fixed on the chip 21, and the heat sink 31 is attached to the chip 21. In this manner, the process of assembling the heat sink component 30 on the chip 21 is finished.

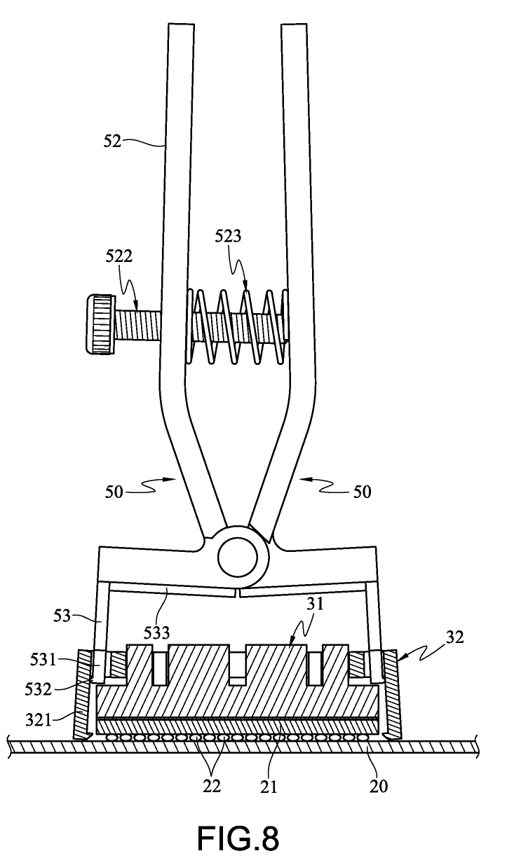

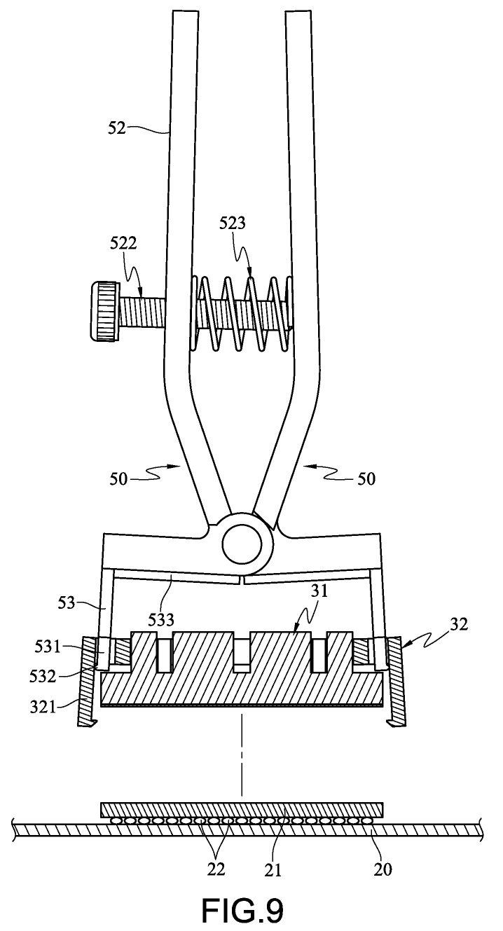

Referring to FIGS. 2, 7, 8, and 9, when the user intends to disassemble the heat sink component 30 from the chip 21 by using the assembly/disassembly pliers of the present invention, it is possible to insert each extending portion 531 of the two pliers bodies 50 into the corresponding through-hole 322 on the fixing member 32, and make the bump 532 on each extending portion 531 lean against the base portion of the hook 321. Then, the two actuating handles 52 are squeezed inwards until the adjusting screw rod 522 leans against the inner side of the actuating handle 52, so as to greatly open the two operating boards 53, and the bump 532 on each extending portion 531 pushes each hook 321 of the fixing member 32 outwards, such that the fixing member 32 is bent to open the hooks 321. At this time, each hook 321 of the fixing member 32 is deformed to open outwards, so as to be separated from the edge of the chip 21 (referring to FIG. 8). In this manner, the process of disassembling the heat sink component 30 from the chip 21 is finished, such that the fixing member 32 and the heat sink 31 are separated from the chip 21 (referring to FIG. 9).

The bump 532 is disposed on the extending portion 531 of the operating board 53, such that the application point of opening the hook 321 may be at the base portion of the hook 321, as compared with the situation of pushing the through-hole 322 and the hook 321 by using the outer side of the whole extending portion 531 instead of disposing the bump 532, the force application is more concentrated, such that the assembly/disassembly pliers of the present invention may labor-savingly open the hooks 321 of the fixing member 32. In addition, the spring 523 and the stopping portion 533 make the assembly/disassembly pliers maintain in the open state satisfying the seizing of the fixing member 32, and the adjusting screw rod 522 makes the assembly/disassembly pliers adjust the actuating scope of the actuating handles 52 according to the fixing members 32 with different specifications, thereby improving the using convenience of the assembly/disassembly pliers.

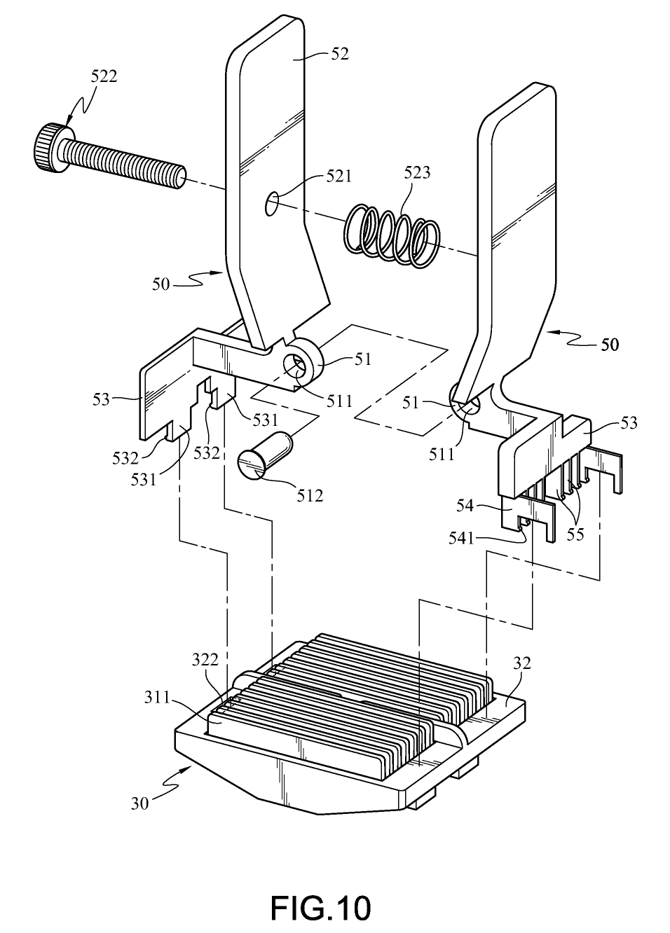

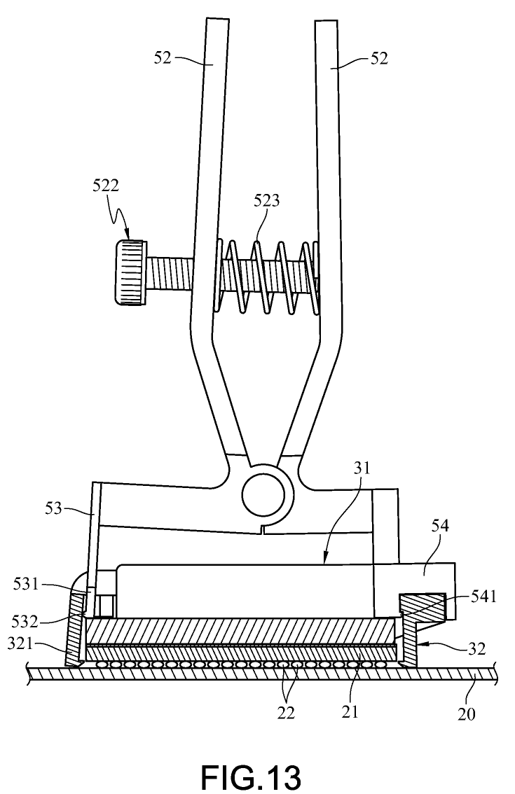

Referring to FIGS. 10 and 13, the assembly/disassembly pliers according to a second embodiment of the present invention includes two pliers bodies 50 pivoted to each other, an adjusting screw rod 522, a spring 523, and a pin 512, and each pliers body 50 has a pivoting portion 51, an actuating handle 52, and an operating board 53. The pivoting portion 51 is located in the middle of the pliers body 50, and the actuating handle 52 and the operating board 53 are respectively disposed on two ends of the pivoting portion 51. The pivoting portion 51 of each pliers body 50 has a pivot hole 511, in which the pin 512 passes through the pivot hole 511 of each pivoting portion 51, so as to pivot the two pliers bodies 50. The operating board 53 of one of the pliers bodies 50 has one or more extending portions 531, and a bump 532 is disposed on an edge of the front end of each extending portion 531. The bumps 532 are disposed towards the direction opposite to the other operating board 53, that is, the bumps 532 are disposed back to back. The end edge of the other operating board 53 has at least one buckling portion 54. In this embodiment, the number of the buckling portions 54 is two. Each buckling portion 54 has a leaning block 541, and a plurality of partition boards 55 arranged in intervals is extended from the operating board 53 between the two buckling portions 54, so as to accommodate the heat sink 31.

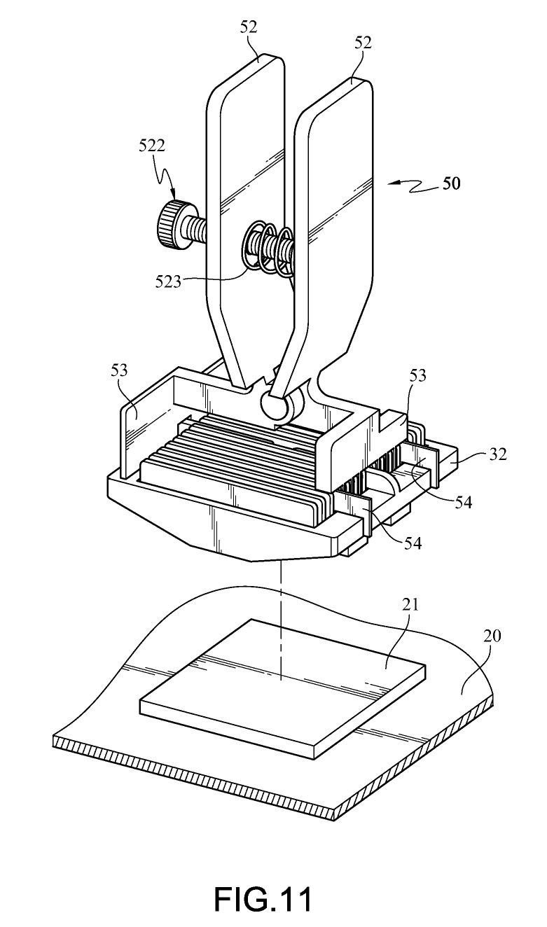

When the user intends to assemble the heat sink component 30 on the chip 21 by using the assembly/disassembly pliers of the present invention, it is possible to insert the extending portion 531 of the pliers bodies 50 having the bump 532 into the corresponding through-hole 322 on the fixing member 32, and make the bump 532 lean against the base portion of the hook 321. The buckling portion 54 of the other pliers body 50 is buckled with the fixing member 32, and the leaning block 541 leans against the inner side of the fixing member 32. Then, the two actuating handles 52 are squeezed inwards to slightly open the two operating boards 53, so as to seize the heat sink component 30 outwards (referring to FIG. 11). Next, the heat sink component 30 is pushed in a manner of being aligned with the chip 21, the hooks 321 of the fixing member 32 may firstly open and then are buckled with the edges of the chip 21, such that the heat sink component 30 is fixed on the chip 21, and the heat sink 31 is attached to the chip 21. In this manner, the process of assembling the heat sink component 30 on the chip 21 is finished.

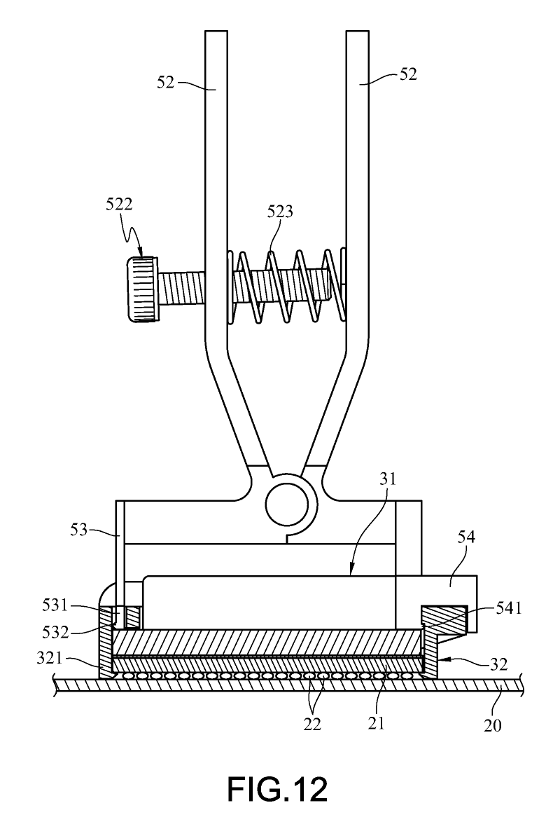

Referring to FIGS. 12 and 13, when the user intends to disassemble the heat sink component 30 from the chip 21 by using the assembly/disassembly pliers of the present invention, it is possible to insert each extending portion 531 of the two pliers bodies 50 into the corresponding through-hole 322 on the fixing member 32, make the buckling portion 54 buckle with the fixing member 32, and make the bump 532 on each extending portion 531 and the leaning block 541 of the buckling portion 54 lean against the base portion of the hook 321 and the inner side of the fixing member 32. Then, the two actuating handles 52 are squeezed inwards until the adjusting screw rod 522 leans against the inner side of the actuating handle 52, so as to greatly open the two operating boards 53, and the bumps 532 and the leaning blocks 541 of the two pliers bodies 50 push each hook 321 of the fixing member 32 outwards, such that the fixing member 32 is bent to open the hooks 321. At this time, each hook 321 of the fixing member 32 is deformed to open outwards, so as to be separated from the edge of the chip 21. In this manner, the process of disassembling the heat sink component 30 from the chip 21 is finished, such that the fixing member 32 and the heat sink 31 are separated from the chip 21 (referring to FIG. 13).

In the present invention, by using the operating board of each pliers body and the bumps disposed back to back on the front ends of the extending portions, the user may operate the actuating handle of each pliers body to make the operating board on the other end open outwards, so as to easily open the hooks on the two sides of the chip through the bumps, thereby conveniently assembling/disassembling the heat sink on or from the chip fabricated by adopting the Pb free BGA fabricating process, and preventing the solder balls from being damaged during the assembly process and the disassembly process. Therefore, the yield of the chip product on the production line is increased with extremely high commercial benefit.

What is claimed is:

1. An assembly/disassembly pliers, comprising two pliers bodies pivoted to each other, wherein an actuating handle and an operating board are disposed on two ends of each pliers body, an end edge of each operating board has at least one extending portion, the at least one extending portion has a bump disposed towards a direction opposite to the other operating board, and the actuating handles are actuated to approach each other, so as to drive the operating boards to shift towards opposite directions to be apart from each other.

2. The assembly/disassembly pliers according to claim 1, further comprising an adjusting screw rod, wherein a threaded hole is disposed on the actuating handle, the adjusting screw rod is screwed in the threaded hole, passes through the actuating handle, and forms an operating pitch with the other actuating handle, so as to limit an actuating scope of the two actuating handles, and the adjusting screw rod rotates relative to the actuating handle to adjust the operating pitch.

3. The assembly/disassembly pliers according to claim 1, further comprising a pin, wherein a pivoting portion is disposed between the actuating handle and the operating board of each pliers body, the pivoting portion has a pivot hole, and the pin passes though the two pivot holes to pivot the two pliers bodies.

4. The assembly/disassembly pliers according to claim 3, wherein a stopping portion is disposed between the operating board and the pivoting portion of each pliers body, and edges of the stopping portions lean against each other to stop the operating board from approaching each other.

5. The assembly/disassembly pliers according to claim 4, further comprising a spring disposed between the actuating handles, wherein two ends of the spring respectively lean against the two actuating handles, the two actuating handles compress the spring, such that the spring normally pushes the two actuating handles towards opposite directions, the two stopping portions lean against each other, and the two operating boards are maintained in the opening scope.

6. An assembly/disassembly pliers, for assembling or disassembling a heat sink on or from a chip, wherein the heat sink is installed in a fixing member, the fixing member has at least two opposite hooks and at least two through-holes disposed beside each hook, the hooks of the fixing member are buckled with edges of the chip, such that the heat sink is attached to the chip, wherein
the assembly/disassembly pliers comprises two pliers bodies pivoted to each other, each pliers body has a pivoting portion, and an actuating handle and an operating board respectively disposed on two ends of the pivoting portion, an opening scope is formed between the two operating boards, each operating board has at least one extending portion, the at least one extending portion has a bump disposed towards a direction opposite to the other operating board, each extending portion is inserted into the through-hole and leans against the hook through the bump, the actuating handles are actuated to approach each other, so as to drive the operating boards to shift towards opposite directions to expand the opening scope, and the bump pushes the hook to be buckled with or separated from the chip, such that the fixing member is installed on or separated from the chip.

7. The assembly/disassembly pliers according to claim 6, further comprising an adjusting screw rod, wherein a threaded hole is disposed on the actuating handle, the adjusting screw rod is screwed in the threaded hole, passes through the actuating handle, and forms an operating pitch with the other actuating handle, so as to limit an actuating scope of the two actuating handles, and the adjusting screw rod rotates relative to the actuating handle to adjust the operating pitch.

8. The assembly/disassembly pliers according to claim 6, further comprising a pin, wherein the pivoting portion of each pliers body has a pivot hole, and the pin passes though the two pivot holes to pivot the two pliers bodies.

9. The assembly/disassembly pliers according to claim 6, wherein a stopping portion is disposed between the operating board and the pivoting portion of each pliers body, and edges of the stopping portions lean against each other, so as to stop the operating board from approaching each other.

10. The assembly/disassembly pliers according to claim 9, further comprising a spring disposed between two actuating handles, wherein two ends of the spring respectively lean against the two actuating handles, the two actuating handles compress the spring, such that the spring normally pushes the two actuating handles towards opposite directions, the two stopping portions lean against each other, and the two operating boards are maintained in an opening scope.

11. An assembly/disassembly pliers, comprising two pliers bodies pivoted to each other, wherein an actuating handle and an operating board are disposed on two ends of each pliers body, an end edge of one of the operating boards has at least one extending portion, the extending portion has a bump disposed towards a direction opposite to the other operating board, an end edge of the other operating has at least one buckling portion having a leaning block, the actuating handles are actuated to approach each other, so as to drive the operating boards to shift towards opposite directions to be apart from each other.

12. The assembly/disassembly pliers according to claim 11, further comprising an adjusting screw rod, wherein a threaded hole is disposed on the actuating handle, the adjusting screw rod is screwed in the threaded hole, passes through the actuating handle, and forms an operating pitch with the other actuating handle, so as to limit an actuating scope of the two actuating handles, and the adjusting screw rod rotates relative to the actuating handle to adjust the operating pitch.

13. The assembly/disassembly pliers according to claim 11, further comprising a pin, wherein a pivoting portion is disposed between the actuating handle and the operating board of each pliers body, the pivoting portion has a pivot hole, and the pin passes though the two pivot holes, so as to pivot the two pliers bodies.

14. The assembly/disassembly pliers according to claim 11, wherein a plurality of partition boards arranged in intervals is extended from the end edge of the operating board having the buckling portion.

15. The assembly/disassembly pliers according to claim 11, further comprising a spring disposed between two actuating handles, wherein two ends of the spring respectively lean against the two actuating handles, the two actuating handles compress the spring, such that the spring normally pushes the two actuating handles towards opposite directions, and the two operating boards are maintained in the opening scope.

16. An assembly/disassembly pliers, for assembling or disassembling a heat sink on or from a chip, wherein the heat sink is installed in a fixing member, one side of the fixing member has at least one hook and at least one through-hole disposed beside each hook, the hooks of the fixing member are buckled with edges of the chip, such that the heat sink is attached to the chip, wherein
the assembly/disassembly pliers comprises two pliers bodies pivoted to each other, each pliers body has a pivoting portion, and an actuating handle and an operating board respectively disposed on two ends of the pivoting portion, an opening scope is formed between the two operating boards, one of the operating boards has at least one extending portion, the extending portion has a bump disposed towards a direction opposite to the other operating board, each extending portion is inserted into the through-hole and leans against the hook through the bump, an end edge of the other operating board has at least one buckling portion having a leaning block, the buckling portion is buckled with the fixing member and leans against an inner side of the fixing member through the leaning block, the actuating handles are actuated to approach each other, so as to drive the operating boards to shift towards opposite directions to be apart from each other, and the bump and the leaning block respectively push the hook and the fixing member, such that the hook is buckled with or separated from the chip, and the fixing member is installed on or separated from the chip.

17. The assembly/disassembly pliers according to claim 16, further comprising an adjusting screw rod, wherein a threaded hole is disposed on the actuating handle, the adjusting screw rod is screwed in the threaded hole, passes through the actuating handle, and forms an operating pitch with the other actuating handle, so as to limit an actuating scope of the two actuating handles, and the adjusting screw rod rotates relative to the actuating handle to adjust the operating pitch.

18. The assembly/disassembly pliers according to claim 16, further comprising a pin, wherein the pivoting portion of each pliers has a pivot hole, and the pin passes though the two pivot holes to pivot the two pliers bodies.

19. The assembly/disassembly pliers according to claim 16, wherein a plurality of partition boards arranged in intervals is further extended from the end edge of the operating board having the buckling portion, so as to accommodate the heat sink.

20. The assembly/disassembly pliers according to claim 16, further comprising a spring disposed between two actuating handles, wherein two ends of the spring respectively lean against the two actuating handles, the two actuating handles compress the spring, such that the spring normally pushes the two actuating handles towards opposite directions, and the two operating boards are maintained in the opening scope.
